(19) United States
(12) Patent Application Publication
(10) Pub. No.: US 2013/0337124 A1
(43) Pub. Date: Dec. 19, 2013

(54) MULTI-FUNCTIONAL FILTRATE MATERIALS FOR ADSORBING ETHYLENE GAS

(71) Applicants: Georgius Abidal Adam, Edensor Park (AU); William Brenden Carlson, Seattle, WA (US)

(72) Inventors: Georgius Abidal Adam, Edensor Park (AU); William Brenden Carlson, Seattle, WA (US)

(73) Assignee: EMPIRE TECHNOLOGY DEVELOPMENT LLC, Wilmington, DE (US)

(21) Appl. No.: 13/810,761

(22) PCT Filed: Jun. 14, 2012
(86) PCT No.: PCT/US12/42359

§ 371 Date: Jan. 17, 2013

(51) Int. Cl. B01J 20/24; A23B 7/154

(52) U.S. Cl. CPC B01J 20/24; A23B 7/154
USPC 426/324; 502/401; 502/402; 252/184; 426/321

(57) ABSTRACT

Compositions for adsorbing ethylene gas, methods for adsorbing ethylene gas and process for making these compositions are provided. A composite material may include at least one modified amorphous high softening point wax and at least one active agent. The active agent may include at least one inorganic compound including at least one metal having at least one free p-orbital and/or at least one free d-orbital. The wax and the active agent may each adsorb ethylene.

### BACKGROUND

Ethylene is a plant hormone involved in induction of various physiological functions such as regulating the growth of roots and shoots, opening of flowers, senescence and ripening of fruits. When present in excess, it can cause fruits and vegetables to ripen prematurely and decay, and flowers to wilt. The presence of ethylene gas is particularly a huge problem in storage and shipment of produce since fruits and vegetables release ethylene gas during the natural ripening process. Fruits, vegetables and flowers are typically packaged in boxes or crates near the producing regions and are transported, often over long distances, to distribution centers and/or markets involving lengthy transportation times. Ethylene gas generated inside the fruit boxes in one localized region can accelerate the fermentation of other fruits, thus spreading the ripening and decaying process in stored containers. This results in the freshness of the transported fruits being compromised. Hence, there is a need for improved packaging and storage systems that can remove ethylene gas, so as to prevent premature spoilage and promote longer shelf life of the product.

### SUMMARY

The present disclosure relates to compositions for adsorbing ethylene gas, methods for adsorbing ethylene gas and process for making these compositions. More particularly, the disclosure relates to using combinations of modified amorphous wax matrix and active fillers.

In an embodiment, a composition for adsorbing ethylene gas includes at least one modified amorphous high softening point wax and at least one active agent, wherein the active agent may be at least one inorganic compound. The inorganic compound further may contain at least one metal with at least one free p-orbital, at least one free d-orbital, or combinations thereof. In some embodiments, both the wax and the active agent are configured to adsorb ethylene.

In an additional embodiment, a method for producing a composite material for adsorbing ethylene gas involves heating an amorphous wax to form a molten wax, mixing the molten wax with a modifying polymer to form a modified wax with high softening point, and mixing the modified wax with the active agent to form the composite material. The active agent may be at least one inorganic compound containing at least one metal compound. The metals may have at least one free p-orbital, at least one free d-orbital, or combinations thereof.

In another embodiment, an article for adsorbing ethylene gas involves a composite material containing at least one modified amorphous high softening point wax and at least one active agent, wherein the active agent may be at least one inorganic compound. The inorganic compound further may contain at least one metal compound with at least one free p-orbital, at least one free d-orbital, or combinations thereof. In some embodiments, both the wax and the active agent are configured to adsorb ethylene.

In a further embodiment, a method for preserving fruits, vegetables, flowers, or combinations thereof, involves providing a sample of a fruit, a vegetable, a flower, or a combination thereof. The method further involves providing a composite material composed of at least one modified amorphous high softening point wax and at least one active agent, wherein the at least one active agent may be at least one inorganic compound. The inorganic compound may further contain at least one metal with at least one free p-orbital, at least one free d-orbital, or a combination thereof. In some embodiments, both the wax and the active agent are configured to adsorb ethylene. The method further involves placing the composite material in sufficiently close proximity to the sample to adsorb ethylene released from the sample.

### BRIEF DESCRIPTION OF THE DRAWINGS

FIG. 1 depicts a general flow diagram of making an ethylene adsorbing material according to an embodiment.

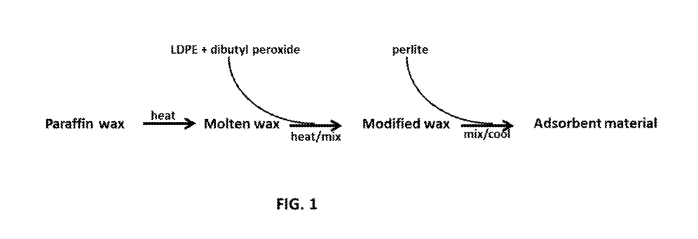

### DETAILED DESCRIPTION

This disclosure is not limited to the particular systems, devices and methods described, as these may vary. The terminology used in the description is for the purpose of describing the particular versions or embodiments only, and is not intended to limit the scope.

The present disclosure provides composite materials to adsorb and remove ethylene gas produced by, but not limited to, fruits, vegetables and flowers. A modified paraffin amorphous wax matrix with new active fillers may be used to remove ethylene gas. The modified wax matrix is efficient in adsorbing ethylene gas released from fruits, vegetables and/or flowers during storage and transportation. In one embodiment, the adsorption material composition may contain at least one amorphous high softening point wax and at least one active agent, wherein the active agent may be at least one inorganic compound. The inorganic compound may further include at least one metal with a free p-orbital, a free d-orbital, or combinations thereof. In some embodiments, both the wax and the active agent are configured to adsorb ethylene. The combination of modified amorphous paraffin wax and an active agent effectively traps any liberated ethylene gas.

In some embodiments, the modified amorphous wax used may be saturated fatty acid glycerides of vegetable origin, saturated fatty acid glycerides of animal origin, hydrogenated oils from saturated fatty acid glycerides of vegetable origin, hydrogenated oils from saturated fatty acid glycerides of animal origin, pentadecanol, hexadecanol, heptadecanol, octadecanol, nonadecanol, eicosanol, cholesterol, cholesteryl palmitate, phytosterol palmitate, or a combination thereof. In some embodiments, the wax matrix may be paraffin wax, polyethylene wax, bees wax, spermaceti, lanolin, ouricury wax, candelilla wax, epicuticular wax, retamo wax, tallow or a combination thereof.

In some embodiments, the paraffin wax may further contain a modifying polymer such as low molecular weight polyethylene, high molecular weight polyethylene, low density polyethylene, high density polyethylene, medium density polyethylene, or combinations thereof.

In additional embodiments, the inorganic compound may include activated carbon, alumina, clay, polysilicate compound, cellulose, or a combination thereof. Examples of polysilicate compound include, but not limited to, perlite, expanded perlite, natural zeolite, synthetic zeolite, aluminosilicate, olivine, a reverse-phase silica, silicone or siloxane.

In some embodiments, the inorganic compound may further contain metal ions belonging to group II metals, group III metals and transition metals. These metal atoms have free p- and/or d-orbitals and are capable of coordinating with the double bond (π-electrons) of ethylene. The combination of amorphous modified wax, polysilicate compounds and metal ions effectively trap any liberated ethylene gas and maintain the freshness of perishables such as fruits, vegetables and flowers.

In other embodiments, the polysilicate compounds may further include ethylene oxidizing agents. The oxidizing agents, such as permanganate compounds, may oxidize the adsorbed ethylene, thus removing ethylene from the composite material surface and keeping the surface active for further ethylene adsorption. The permanganate compounds may include potassium permanganate, sodium permanganate or combinations thereof.

In an embodiment, the polysilicate compounds may further contain ethylene deactivating agents, such as sulfur compounds and phosphate compounds. The sulfur and phosphate compounds react with adsorbed ethylene to form ethylsulfate and ethylphosphate, respectively, thus deactivating the adsorbed ethylene.

In some embodiments, the polysilicate compounds may further contain natural and/or synthetic auxins. These auxins may react with adsorbed ethylene and deactivate it, thus removing the adsorbed ethylene and keeping the surface of the material active for further ethylene adsorption. In some embodiments, the auxins may react with ethylene forming sources and de-activate ethylene. The auxins may be 2,4,5-trichlorophenoxyacetic acid, 2,4-dichlorophenoxyacetic acid, α-naphthalene acetic acid, 4-amino-3,5,6-trichloropicolinic acid, 2-methoxy-3,6-dichlorobenzoic acid, indole-3-butyric acid, 4-chloroindole-3-acetic acid, 2-phenylacetic acid, indoleacetaldehyde, indolepyruvic acid or a combination thereof.

In some embodiments, the ethylene adsorption material may be in the form of particulate matter, a powder, a granule or combinations thereof. In some embodiments, the adsorbed ethylene gas may be removed, and the adsorption material may be recycled for further ethylene adsorption. For example, the adsorption material can be melted under vacuum and then reformed into pellets again. The oxidizing agents in the polysilicate compounds may help in oxidizing the ethylene and removing them from the system.

Also provided herein are methods to prepare the composite materials for adsorbing ethylene. In some embodiments, a method for producing a composite material for adsorbing ethylene gas comprises: (a) heating an amorphous wax to form a molten wax; (b) heating and mixing the molten wax with a modifying polymer to form a modified wax; and (c) mixing the molten modified wax with the active agent to form the composite material. The active agent may be an inorganic compound having at least one metal with at least one free p-orbital, at least one free d-orbital, or a combination thereof. The metal ions may be selected from group II metals, group III metals and transition metals.

In some embodiments, the amorphous wax may be fatty acid glycerides of vegetable origin, saturated fatty acid glycerides of animal origin, hydrogenated oils from saturated fatty acid glycerides of vegetable origin, hydrogenated oils from saturated fatty acid glycerides of animal origin, pentadecanol, hexadecanol, heptadecanol, octadecanol, nonadecanol, eicosanol, cholesterol, cholesteryl palmitate, phytosterol palmitate, or a combination thereof. In some embodiments, the wax may be paraffin wax, polyethylene wax, spermaceti, lanolin, ouricury wax, candelilla wax, epicuticular wax, retamo wax, or tallow.

In some embodiments, the inorganic compound may be activated carbon, alumina, clay, polysilicate compound, cellulose, or a combination thereof. In some embodiments, the polysilicate compound may be natural zeolite, a synthetic zeolite, perlite, expanded perlite, an aluminum polysilicate, olivine, reverse-phase silica, a silicone, a siloxane, or a combination thereof. In other embodiments, the polysilicate compound may further contain ethylene oxidizing agents and ethylene deactivating agents.

In some embodiments, the amorphous high softening point wax is heated to form molten wax at a temperature of about 80° C. to about 150° C., about 90° C. to about 150° C., about 100° C. to about 150° C., about 120° C. to about 150° C., about 100° C. to about 115° C. Specific examples of the temperature include 80° C., 85° C., 100° C., 115° C., 120° C., 150° C. and ranges between any two of these values.

The viscosity, hardness, melting point and reactivity of the waxes may be modified by including various polymers. In some embodiments, the modifying polymer may be low molecular weight polyethylene, high molecular weight polyethylene, low density polyethylene, high density polyethylene, medium density polyethylene or a combination thereof. In some embodiments, the wax and the modifying polymer are mixed in a weight to weight ratio of about 99:1 to about 85:15, of about 99:1 to about 90:10, of about 99:1 to about 95:5 or of about 99:1 to about 98:2. Specific examples include about 99:1, about 95:5, about 90:10, about 85:15, and ranges between any two of these values.

The wax is cross-linked with polymers in the presence of catalysts such as peroxides. In additional embodiments, the molten wax and the modifying polymer are mixed along with an organic peroxide. In some embodiments, the organic peroxide may be dibutyl peroxide, dibenzoly peroxide, dilauryl peroxide, or combinations thereof. In some embodiments, the wax and peroxide are mixed in a weight to weight ratio of about 100:0.01 to about 100:0.025, about 100:0.01 to about 100:0.02, about 100:0.01 to about 100:0.015. Specific examples include about 100:0.01, about 100:0.015, about 100:0.02, about 100:0.025, and ranges between any two of these values.

In some embodiments, the molten wax, modifying polymer and the peroxide are continuously mixed and heated to a temperature of about 100° C. to about 115° C., about 100° C. to about 110° C., about 100° C. to about 105° C. Specific examples include about 100° C., about 102° C., about 105° C., about 110° C., about 115° C., and ranges between any two of these values. Specific time periods for heating this mixture may be about 20 minutes, about 30 minutes, about 45 minutes, about 1 hour, about 2 hours, and the like.

The modified molten wax is mixed with the active filler agents by any one or more of the following means: (a) spraying the modified wax solution in hydrocarbon solvents on the active material; (b) mixing the modified wax and the active agent to form an emulsion; (c) mixing the modified wax suspension in boiling water with the active agent to form the suspended composite material; and (d) impregnating the active agent with the modified wax solution by soaking, dipping, spraying and the like. In some embodiments, the molten modified wax is mixed with the active agent and cooled to a temperature until the mixture solidifies to form a solid wax-active agent material. The cooling rates may be about 2° C./minute to about 4° C./minute, about 2° C./minute to about 5° C./minute, about 2° C./minute to about 7° C./minute, or about 1° C./minute to about 10° C./minute. Specific cooling rates may be about 2° C./minute, about 3° C./minute, about 5° C./minute, and ranges between any two of these values.

The wax-active agent material may be converted into particulate matter by shearing, grinding, crushing, and/or powdering the material. In other embodiments, the modified wax emulsion or solution is sprayed on the active agents, dried and ground to a final filtering product. In additional embodiments, the molten modified wax and the active agents may be suspended in boiled water with efficient mixing and heating until homogeneous fine suspension is obtained. The suspension may be cooled with continuous vigorous mixing until the suspended particles become solidified. The product is left to settle, separated and dried. The cooling rates may be about 2° C./minute to about 4° C./minute, about 2° C./minute to about 5° C./minute, about 2° C./minute to about 7° C./minute, or about 1° C./minute to about 10° C./minute. Specific cooling rates may be about 2° C./minute, about 3° C./minute, about 5° C./minute, and ranges between any two of these values.

The adsorbent material described herein may be incorporated into an article used for adsorbing ethylene. The article may be, but is not limited to, a film, a bag, a container, a sachet, a filter, a cartridge, or a packaging material. For example, the article may be a filter that is incorporated into an air handling system such as a refrigeration unit on a large shipping container. In another embodiment, the adsorbent material may be present in a gas-permeable small satchel, and placed inside of a food storage container. The satchel may be easily replaced or discarded by the end user. The adsorbent material may be used in processing facilities, large shipping containers, retail stores, and individual packaging for consumers and small packages for shopping markets. Use of the technology will reduce spoilage of product resulting in increased shelf life.

The embodiments described herein may efficiently remove ethylene gas from environments around fruits, vegetables, and general produce. The adsorbent materials may also be safely disposed of after use and/or recycled. The various configurations do not impart any change in taste, color, or appearance of fruits and/or vegetables.

### Example 1

### Method for Preparing Adsorbent Material

### Sample 1

About 500 grams of food grade paraffin wax was heated to a temperature of 110° C. to form a molten wax substance. About 10 grams of LDPE (low density polyethylene, density 0.923 grams/cm³) and 50 milligrams of dibutyl peroxide were added to the molten wax slowly, and the heating was further continued for 30 minutes with continuous efficient mixing. About 300 grams of iron salt-impregnated perlite was added to this mixture with continuous stirring, and the mixture was cooled gradually (around 3° C./minute) to room temperature. The solidified mixture was ground using a laboratory scale ball mill to obtain the adsorbent material in particulate form. The iron salt-impregnated perlite was obtained by soaking the perlite in 10-20% ferric chloride solution for 24 hours followed by removing the excess of the ferric chloride solution and drying the perlite in an oven at 90° C. for about 8 hours.

### Example 2

### Method for Preparing Adsorbent Material

### Sample 2

About 500 grams of food grade paraffin wax was heated to a temperature of 110° C. to form a molten wax substance. About 10 grams of LDPE (low density polyethylene, density 0.923 grams/cm³) and 50 milligrams of dibutyl peroxide were added to the molten wax, and the heating was further continued for 30 minutes with continuous efficient mixing. About 300 grams of potassium permanganate coated/impregnated perlite was added to this mixture with constant stirring, and the mixture was cooled gradually (around 3° C./minute) to room temperature. The solidified mixture was ground using a laboratory scale ball mill to obtain the adsorbent material in particulate form. The potassium permanganate-coated/impregnated perlite was obtained by soaking the perlite powder in 20 percent potassium permanganate solution for 24 hours followed by removing the excess of the potassium permanganate solution and drying the perlite in an oven at 80° C. under vacuum for about 6 hours.

### Example 3

### Method for Preparing Adsorbent Material

### Sample 3

About 500 grams of high softening point casting wax was heated to a temperature of 115° C. to form a molten wax substance. About 10 grams of HDPE (high density polyethylene, density 0.96 grams/cm³) and 25 milligrams of dibutyl peroxide were added to the molten wax, and the heating was further continued for 30 minutes with continuous efficient mixing. About 200 grams of potassium permanganate-impregnated perlite (obtained as shown in EXAMPLE 2) was added slowly with continuous mixing to obtain an active filler loading of 30-60%. The semi-solid product was cooled to room temperature, and the material was pelletized or ground to obtain the final product.

### Example 4

### Method for Preparing Adsorbent Material

### Sample 4

About 500 grams of casting wax was dissolved in 200 grams of the commercial solvent for wax (D-wax-10) with continuous efficient mixing. The high softening point wax solution was sprayed on a stream of active agents (perlite powder, perlite impregnated with permanganate, perlite impregnated with ferric chloride or perlite impregnated with synthetic auxins). The perlite-wax matrix later was transformed into pellets and then dried at 80° C. for 3 hours, ground to powder and used as filtrate.

### Example 5

### Method for Preparing Adsorbent Material

### Sample 5

About 500 grams of modified high softening point wax was suspended in boiling water with efficient mixing. About 250 grams perlite impregnated with potassium permanganate was added slowly with continuous mixing. The suspension was cooled gradually at the rate of 3-5° C./minute with continuous mixing until it reaches room temperature. The mixing was stopped and the fine wax particles loaded with active perlite was allowed to settle down, separated and dried at 60° C. for three hours.

### Example 6

### Method for Preparing Adsorbent Material

### Sample 6

About 500 grams of high softening point wax was dissolved in 200 grams of n-hexane. About 15 grams of cetrimide surfactant was added to the above solution with continuous mixing. About 600 grams of water was added and mixing was further continued until a homogenous emulsion is obtained. The wax emulsion was sprayed on a stream of active agents (perlite powder, perlite impregnated with permanganate, perlite impregnated with ferric chloride or perlite impregnated with synthetic auxins). The perlite-wax matrix later was transformed into pellets and then dried at 80° C. for 3 hours, ground to powder and used as filtrate.

### Example 7

### Preserving Fruits

About 50 grams of adsorbent material (Sample 1) is packaged in a 10 inch by 10 inch gas permeable textile and is placed in a closed container containing unripe apples and bananas. A similar container with fruits but with no adsorbent material is used for comparison. The containers are placed at room temperature and the condition of the fruits are examined at the end of 7 days. The fruits in the container with the adsorbent material will be unripe/partially ripe, whereas the fruits in the control container will be fully ripe.

### Example 8

### Preserving Flowers

Eight tulip buds are chosen and placed in two closed containers filled with water, with each container having four buds. About 50 grams of the granular adsorbent material (Sample 2) in a sachet is placed in one of the container, away from water. The containers are placed at room temperature and the buds are examined after four days. The buds in the container with the adsorbent material will stay fresh and while the buds in the second container will bloom and wither.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist or” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A composite material comprising:
at least one modified amorphous high softening point wax; and
at least one active agent,
wherein the active agent comprises at least one inorganic compound comprising at least one metal having at least one free p-orbital, at least one free d-orbital, or a combination thereof, and
wherein both the wax and the active agent adsorb ethylene.

2. The composite material of claim 1, wherein the modified amorphous high softening point wax is saturated fatty acid glycerides of vegetable origin, saturated fatty acid glycerides of animal origin, hydrogenated oils from saturated fatty acid glycerides of vegetable origin, hydrogenated oils from saturated fatty acid glycerides of animal origin, pentadecanol, hexadecanol, heptadecanol, octadecanol, nonadecanol, eicosanol, cholesterol, cholesteryl palmitate, and phytosterol palmitate, paraffin wax, polyethylene wax, bees wax, spermaceti, lanolin, ouricury wax, candelilla wax, epicuticular wax, retamo wax, tallow or a combination thereof.

3. (canceled)

4. The composite material of claim 1, wherein the wax comprises paraffin wax and at least one modifying polymer selected from the group consisting of low molecular weight polyethylene, high molecular weight polyethylene, low density polyethylene, high density polyethylene, medium density polyethylene and combinations thereof.

5. The composite material of claim 1, wherein the inorganic compound is activated carbon, alumina, clay, polysilicate compound, cellulose, a perlite, an expanded perlite, a natural zeolite, a synthetic zeolite, an aluminosilicate, olivine, a reverse-phase silica, a silicone, a siloxane or a combination thereof.

6-7. (canceled)

8. The composite material of claim 1, wherein the inorganic compound comprises a polysilicate compound comprising a permanganate compound.

9-10. (canceled)

11. The composite material of claim 1, wherein the inorganic compound comprises a polysilicate compound comprising an ethylene deactivating agent, wherein the deactivating agent comprises one or more of the following: a sulfur compound, a phosphate compound, or an auxin.

12. (canceled)

13. The composite material of claim 1, wherein the metal is selected from the group consisting of group II metals, group III metals, transition metals and combinations thereof.

14. (canceled)

15. The composite material of claim 1, wherein the composite material is further characterized by being formed as a particulate matter, a powder, a granule or a combination thereof.

16. The composite material of claim 1, wherein the composite material is reusable for adsorbing ethylene.

17. A method of preparing a composite material, the method comprising:
providing at least one amorphous wax and at least one active agent,
wherein the active agent comprises at least one inorganic compound comprising at least one metal having at least one free p-orbital, at least one free d-orbital, or a combination thereof;
heating the amorphous wax to form a molten wax;
contacting the molten wax with a modifying polymer to form a modified wax with high softening point; and
contacting the modified wax with the active agent to form the composite material.

18-25. (canceled)

26. The method of claim 17, wherein heating the amorphous wax comprises heating the amorphous wax to a temperature of about 80° C. to about 150° C. to form the molten wax.

27. (canceled)

28. The method of claim 17, wherein contacting the molten wax with the modifying polymer comprises contacting the molten wax with the modifying polymer in a weight to weight ratio of about 99:1 to about 85:15.

29. The method of claim 17, wherein contacting the molten wax with the modifying polymer further comprises contacting the molten wax and the modifying polymer with at least one organic peroxide.

30. (canceled)

31. The method of claim 29, wherein the wax and the at least one organic peroxide are contacted in a weight to weight ratio of about 100:0.01 to about 100:0.025.

32. (canceled)

33. The method of claim 29, wherein contacting the molten wax and the modifying polymer with the at least one organic peroxide comprises heating the molten wax, modifying polymer and the at least one organic peroxide to a temperature of about 100° C. to about 115° C.

34. The method of claim 29, wherein contacting the molten wax and the modifying polymer with the at least one organic peroxide comprises heating the molten wax, modifying polymer and the at least one organic peroxide for about 30 minutes.

35-37. (canceled)

38. The method of claim 17, wherein contacting the modified wax with the active agent comprises spraying the modified wax on the active agent.

39. The method of claim 38, further comprising drying the wax-active agent material and converting the wax-active agent material to a particulate matter by one or more of shearing, grinding, crushing or powdering.

40. The method of claim 17, wherein contacting the modified wax with the active agent comprises mixing the modified wax suspended in boiling water with the active agent.

41. The method of claim 40, further comprising drying the wax-active agent material and converting the wax-active agent material to a particulate matter by one or more of shearing, grinding, crushing or powdering.

42-43. (canceled)

44. An article for adsorbing ethylene, the article comprising:
a composite material comprising a modified amorphous high softening point wax and at least one active agent,
wherein the active agent comprises at least one inorganic compound comprising at least one metal having at least one free p-orbital, at least one free d-orbital, or combinations thereof, and
wherein both the wax and the active agent adsorb ethylene.

45-46. (canceled)

47. The article of claim 44, wherein the article is a film, a bag, a container, a sachet, a filter, a cartridge, or a packaging material.

48. The article of claim 44, wherein the article is configured to adsorb ethylene from fruits, vegetables, flowers, warehouses, shipping containers, boxes, bags or combinations thereof.

49. A method for preserving fruits, vegetables, flowers, or combinations thereof, the method comprising:
providing a sample of a fruit, a vegetable, a flower, or a combination thereof;
providing a composite material comprising at least one modified amorphous high softening point wax and at least one active agent, wherein the active agent comprises at least one inorganic compound comprising at least one metal having at least one free p-orbital, at least one free d-orbital, or a combination thereof, wherein both the wax and the active agent adsorb ethylene; and
placing the composite material in sufficiently close proximity to the sample to adsorb ethylene released from the sample.

50-51. (canceled)

52. The method of claim 49, wherein the composite material is configured to hold the sample.

53. The method of claim 49, wherein the composite material is incorporated into a film, a bag, a container, a sachet, a filter, a cartridge, or a packaging material.

54. The method of claim 49, wherein the composite material is reusable for adsorbing ethylene.
